(19) United States
(12) Patent Application Publication
(10) Pub. No.: US 2026/0067658 A1
(43) Pub. Date: Mar. 5, 2026

(54) SHORT-RANGE COMMUNICATION DEVICE EMERGENCY RESPONSE SYSTEM

(71) Applicant: T-Mobile USA, Inc., Bellevue, WA (US)

(72) Inventor: Keldon Beckley Fischer, Kirkland, WA (US)

(21) Appl. No.: 18/817,992

(22) Filed: Aug. 28, 2024

(51) Int. Cl. H04W 4/90; H04M 3/51; H04W 76/50

(52) U.S. Cl. CPC H04W 4/90; H04M 3/5116; H04W 76/50

(57) ABSTRACT

A method and an apparatus disclosed herein are directed to establishing an emergency call to a public-safety answering point (PSAP) by a first user equipment (UE) when a cellular communication service for the first UE is not immediately available. The first UE may activate an emergency communication application, and in response to activating the emergency communication application, search for a cellular communication network service for the first UE. In response to failing to obtain the cellular communication network service, the first UE may broadcast an SOS message using a short-range wireless communication scheme, and establish communication with a second UE using the short-range wireless communication scheme. The first UE may cause the second UE to: establish communication with a public-safety answering point (PSAP) using an available cellular communication network service for the second UE, and forward the SOS message to the PSAP.

### BACKGROUND

Modern telecommunications systems include heterogeneous mixtures of second, third, fourth, and fifth generation (2G, 3G, 4G, and 5G) cellular-wireless access technologies, which can be cross-compatible and can operate collectively to provide data communication services. Global Systems for Mobile (GSM) is an example of 2G telecommunications technologies; Universal Mobile Telecommunications System (UMTS) is an example of 3G telecommunications technologies; and Long Term Evolution (LTE), including LTE Advanced, and Evolved High-Speed Packet Access (HSPA+) are examples of 4G telecommunications technologies. As increased capabilities of user equipment (UE) enable greater data consumption, placing increased demands on networks, the 5G telecommunication technologies are designed to combine both an evolution and revolution of the existing LTE/LTE-A mobile networks to provide a much higher connectivity, greater throughput, much lower latency, and ultra-high reliability to support new use cases and applications.

The modern telecommunications systems also include Internet Protocol (IP) Multimedia Subsystems (IMSs) for delivering IP multimedia services allowing users of user equipment (UEs) to access various services and applications. The IMS may be used to set up communications between IMS systems supported by different communication network providers and other networks such as wireless local area network (WLAN) and fixed lines.

UEs, also referred to as cellular or mobile phones, compatible with the modern telecommunications systems may additionally be capable of communicating with local devices and systems, such as smartwatches, printers, other UEs, servers, and the like, using short-range communication systems, such as Bluetooth, WiFi, ZigBee, Near Field Communication (NFC), and other communication methods and standards. A Bluetooth enabled device may be able to initiate an emergency call to a public-safety answering point (PSAP) via its paired UE, however, establishing communication to the PSAP from the paired UE requires a cellular communication coverage for the paired UE.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a diagram of a situation in which a short-range communication device emergency response system is being used.

FIG. 2 illustrates an example process for sending an emergency message using the short-range communication device emergency response system.

FIG. 3 illustrates an example detail process of one of blocks of FIG. 2.

FIG. 4 illustrates an example detail process of one of blocks of FIG. 2.

FIG. 5 is an example block diagram of a user equipment (UE) that may be used to implement various components, modules, and/or functional elements of the short-range communication device emergency response system.

### DETAILED DESCRIPTION

A method, apparatus, and system disclosed herein are directed to establishing an emergency call to a public-safety answering point (PSAP) by a user equipment (UE) when a cellular communication service for the UE is not immediately available. The UE may first establish communication with a nearby UE using a short-range communication and cause the nearby UE to complete establishing the emergency call to the PSAP via a cellular communication service available to the nearby UE.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

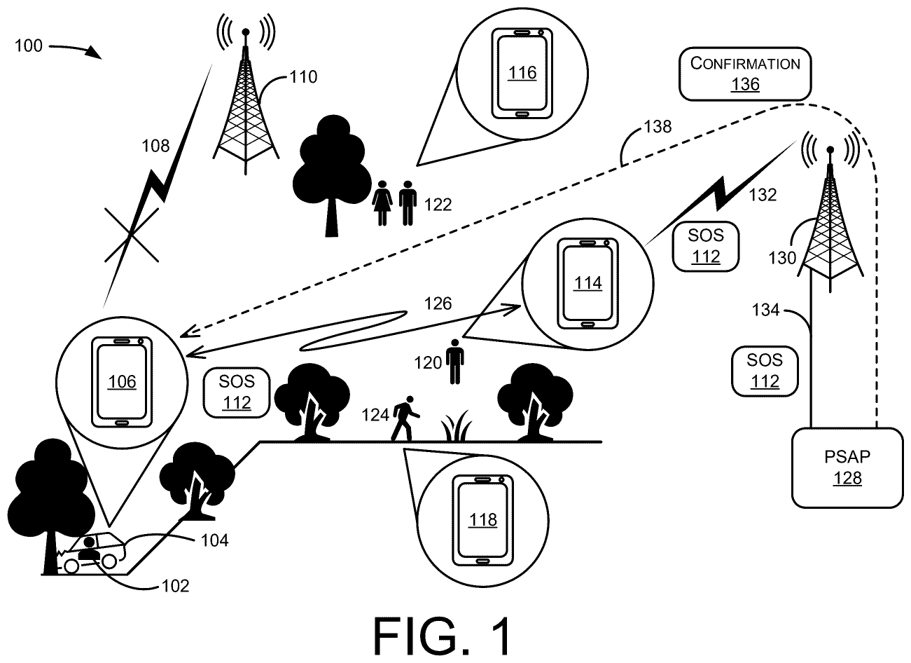

FIG. 1 illustrates a diagram 100 of a situation in which a short-range communication device emergency response system is being used. In FIG. 1, a first user 102 in a car 104 is shown to be in an accident. The first user 102 may attempt to call for help using his mobile phone, a first UE 106, however, may find that a cellular communication service is not currently available for the first UE 106, that is, the first UE 106 is unable to establish a first cellular network communication 108 with a first base station 110. In response to being unable to establish the first cellular network communication 108, the first UE 106 may broadcast an emergency, or SOS, message 112 using a short-range wireless communication scheme, such as Wi-Fi, Bluetooth, Zigbee, and the like, and establish communication with one or more UEs of one or more users nearby. In this example, three nearby UEs, a second UE 114, a third UE 116, and a fourth UE 118 of three nearby users, a second user 120, a third user 122, and a fourth user 124 are shown. In response to receiving the broadcast, the three nearby UEs, the second UE 114, the third UE 116, and the fourth UE 118 may generate, or be caused to generate, an alert to notify the second user 120, the third user 122, and the fourth user 124 that there is someone nearby needs help. Each of the nearby users (e.g., second user 120, the third user 122, and the fourth user 124) is a user that has previously consented to receiving SOS messages at their respective UE, for the purpose of potentially rendering assistance to another user of another UE who is experiencing an emergency event and/or relaying a SOS message from another UE to a PSAP for such an emergency event. Each user may provide their consent by installing an emergency communication application and providing consent via a consent acknowledgment interface of the emergency communication application. For example, the first UE 106 may establish a short-range wireless communication 126 with another UE, such as the second UE 114, and provide the SOS message 112 to the second UE 114. In response to receiving the SOS message 112, the second UE 114 may contact a public-safety answering appoint (PSAP) 128 via a second base station 130 by establishing a second cellular network communication 132 with the second base station 130, and forward the SOS message 112 to the PSAP 128, for example via a communication line 134, such as a landline and/or a wireless connection, from the second base station 130 to the PSAP 128. In response to receiving the SOS message 112, the PSAP 128 may send a confirmation of receipt 136 to the first UE 106 via the second UE 114, as shown by a communication link 138 (a dotted arrow line), through the second base station 130. In this example, the communication link 138 includes the short-range wireless communication 126 between the first UE 106 and the second UE 114, the second cellular network communication 132 between the second UE 114 and the second base station 130, and the communication line 134 between the second base station 130 and the PSAP 128. The first UE 106 and the PSAP 128 may now communicate with each other via the communication link 138. The PSAP 128 may inquire the status of the accident and/or the first user 102 and determine and prepare an appropriate response, such as fire, chemical, electrical, and/or mechanical response gears and team as well as medical and other needed staff.

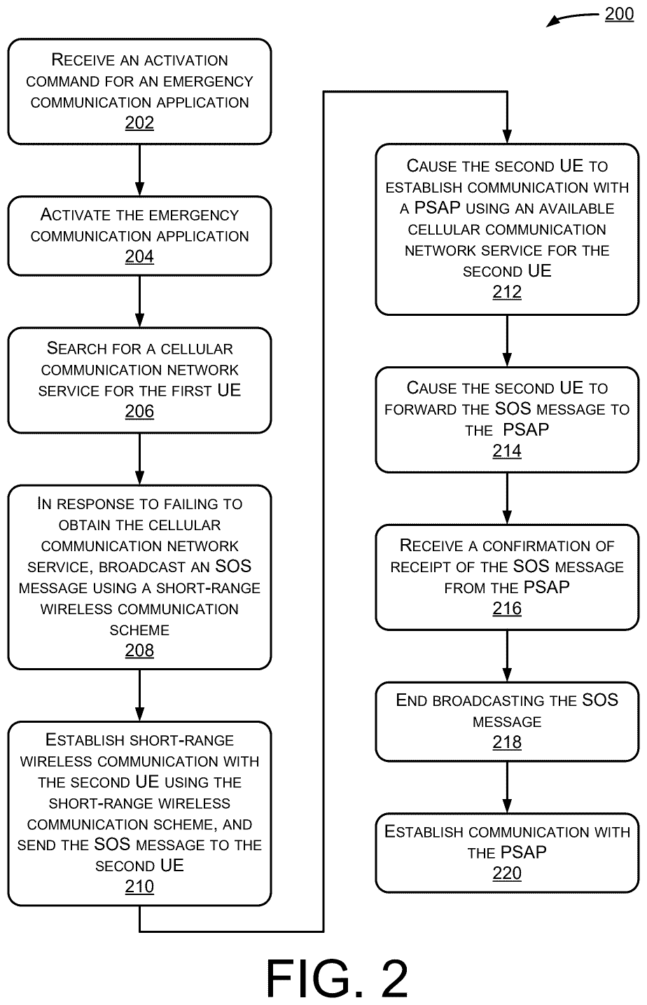

FIG. 2 illustrates an example process 200 for sending an emergency message using the short-range communication device emergency response system. As described above with reference to FIG. 1, the short-range communication device emergency response system may be initiated in response to an incident or an accident, and unless specifically indicated, the process 200 is understood to be performed by a UE, such as the first UE 106, and more specially by one or more processors of the first UE 106.

At block 202, the first UE 106 may receive an activation command for an emergency communication application. For example, a first user 102 of the first UE 106, may activate the emergency communication application after being involved in an accident as shown above with reference to FIG. 1, and the emergency communication application may be activated at block 204. Activating the emergency communication application may cause the first UE 106 to initiate a voice call and/or sending a message, such as the SOS message 112, to an emergency service, such as the PSAP 128. Alternatively, the emergency communication application may be set to automatically activate in response to detecting an event, such as an impact due to an accident. For example, an internal accelerometer (not shown) of the first UE 106 may detect a sudden deceleration above a threshold deceleration value, and the first UE 106 may determine that an accident has occurred. The first UE 106 may also be linked to an internal detection system (not shown) of the car 104, and receive an alert from the internal detection system that airbags of the car 104 have been deployed. At block 206, in response to activating the emergency communication application, the first UE 106 may search for a cellular communication network service for the first UE 106. Depending on the capabilities of the first UE 106, the cellular communication network service that the first UE 106 searches may include one or more of the 2G, 3G, 4G, 5G, or other cellular-wireless access technologies. In response to failing to obtain the cellular communication network service, such as the first cellular network communication 108 with the first base station 110, the first UE 106 may broadcast an emergency message, such as the SOS message 112, using a short-range wireless communication scheme, such as Wi-Fi, Bluetooth, Zigbee, and the like, at block 208. The first UE 106 may, at block 210, establish communication, such as the short-range wireless communication 126, with a nearby UE, such as the second UE 114, using the short-range wireless communication scheme, and send the SOS message 112 to second UE 114. Because the first UE 106 broadcasts the SOS message 112, any of a plurality of nearby UEs, such as the second UE 114, the third UE 116, and the fourth UE 118 as shown in FIG. 1, may receive the SOS message 112 and attempt, or be caused to attempt, to establish communication with the PSAP 128.

Additionally, or alternatively, in response to receiving the SOS message 112 broadcast from the first UE 106, the second UE 114 may, or may be caused to, alert the second user 120 of the second UE 114. The alert may include audible, vibrational, and/or visual alert, and notify the second user 120 that there is someone nearby in distress seeking help, and may also display, or be caused to display, location information of the first UE 106, for example, the locations of the first UE 106 and the second UE 114 on a map application. For example, such alerts may be displayed by a corresponding emergency communication application on the second UE 114. The alert may additionally notify that the second UE 114 is now attempting to contact the PSAP 128 using the second cellular network communication 132. The second UE 114 may also allow, or be allowed, to communicate with the first UE 106. For example, upon generating the alert, the second UE 114, via a corresponding emergency communication application, may provide a prompt for the second user 120 to begin a conversation, audibly or textually, with the first user 102. The emergency communication application of the first UE 106 may also indicate the status of the SOS message 112, for example, by displaying the number of available UEs nearby, such as “3 users nearby” indicating the nearby UEs, the second 114, the third UE 116, and the fourth UE 118 as discussed above with referenced to FIG. 1.

The first UE 106, under the direction of the emergency communication application, may broadcast the SOS message 112 periodically, every five seconds for example, to reduce battery power consumption of the first UE 106. The SOS message 112 may be created by including preselected information, a time stamp corresponding to a time of the activation of the emergency communication application, a location of the first UE 106 at the time of the activation, for example via a GPS data of the first UE 106, an identity of the first UE 106, such as an international mobile equipment identity (IMEI) and/or of a phone number of the first UE 106, and personal information of the first user 102 of the first UE 106, such as residential address, age, and sex of the first user 102. Some of the preselected information may be automatically extracted from internal data of the first UE 106, or may have been previously entered by the first user 102. The SOS message 112 may additionally include a unique identifier, such as a serial code, a hash, a checksum, and/or other identification information unique to the SOS message 112. The SOS message 112 may also be supplemented by additional information entered after the activation of the emergency communication application by the first user 102. For example, upon the activation of the emergency communication application, the first UE 106 may present inquiries, or questions, to the first user 102, and the SOS message 112 may be supplemented with responses to the inquiries provided by the first user 102. The inquiries may include a nature of the incident, such as a car accident, personal injuries, fire, chemical spill, etc., a number of people involved and/or injured, a landmark near the location of the incident, and other relevant information. The first UE 106 may audibly and/or textually provide the inquiries to the first user 102, and receive the responses from the first user 102 audibly via a microphone of the first UE 106 and/or textually via a user interface (UI) of the first UE 106. At least some information included in the SOS message 112 may be displayable, or viewable, on a receiving device at the PSAP 128.

Once the short-range wireless communication 126 is established with the second UE 114, the first UE 106 may cause the second UE 114 to establish communication with a public-safety answering point (PSAP), such as the PSAP 128, using an available cellular communication network service, such as the second cellular network communication 132 with the second base station 130, for the second UE 114 at block 212, and cause the second UE 114 to forward the SOS message 112 to the PSAP 128 at block 214. In various embodiments, the first UE 106 and the second UE 114 may perform these operations under the direction of the emergency communication applications installed on the first UE 106 and the second UE 114. After the second UE 114 establishes communication with the PSAP 128 at block 212, in response to receiving further attempts to establish communication with the PSAP 128 from other UEs, such as the third UE 116 and the fourth UE 118, the PSAP 128 may send, or be caused to send, a neutralizing message to the third UE 116 and the fourth UE 118 to stop the third UE 116 and the fourth UE 118 from further attempting to establish communication with the PSAP 128. The neutralizing message includes the unique identifier identifying the SOS message 112, such that this neutralizing message is only applicable to the SOS message 112.

The first UE 106 may receive a confirmation of receipt 136 of the SOS message 112 from the PSAP 128 via the second UE 114 at block 216. The confirmation of receipt 136 may include a contact information of the PSAP 128, such as a phone number and a physical and an email addresses of the PSAP 128. The UE 106, in response to receiving the confirmation of receipt 136, may end broadcasting the SOS message 112 at block 218 and establish communication with the PSAP 128 via the communication link 138 at block 220. That is, the first UE 106 and the PSAP 128 are able to communicate with each other, where the second UE 114 may automatically perform, or may be caused to automatically perform, as a relay between the first UE 106 and the PSAP 128 while the emergency communication application is active. For example, an inquiry, such as a health status of the first user 102 by text and/or voice, from an operator of the PSAP 128 to the first user 102 is first sent to the second UE 114 via the second cellular network communication 132, and second UE 114, performing as a relay, forwards the inquiry to the first UE 106 via the short-range wireless communication 126. Similarly, a text and/or voice response from the first user 102 to the inquiry may first be sent from the first UE 106 to the second UE 114 via the short-range wireless communication 126, and the second UE 114, performing as a relay, forwards the response to the PSAP 128, via the second cellular network communication 132, to the PSAP 128.

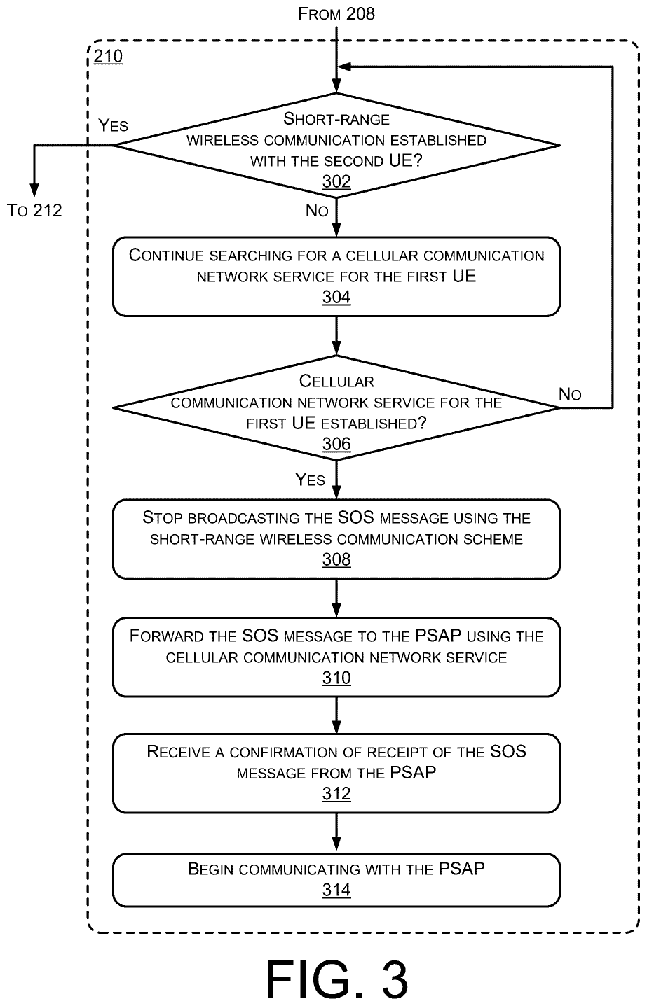

FIG. 3 illustrates an example detail process of block 210 of FIG. 2, which the first UE 106 may additionally, or alternatively, perform to establish communication directly with the PSAP 128 using a cellular communication network service. At block 302, the first UE 106 may determine whether the short-range wireless communication has been established with a nearby UE, such as the second UE 114. If the first UE 106 determines that the short-range wireless communication with the second UE 114 has been established (“YES” branch), then the process may proceed to block 212 as described above with reference to FIG. 2. If the first UE 106 determines that the short-range wireless communication has not yet been established with the second UE 114 (“NO” branch), the first UE may continue searching for a cellular communication network service for the first UE 106 at block 304, and may determine whether the cellular communication network service is established for the first UE 106 at block 306. If the first UE 106 determines that the cellular communication network service has not yet been established for the first UE 106 (“NO” branch), then the process may loop back to block 302. If the first UE 106 determines that the cellular communication network service has been established for the first UE 106 (“YES” branch), then the first UE 106 may stop broadcasting the SOS message 112 using the short-range wireless communication scheme at block 308, and forward the SOS message 112 to the PSAP 128 using the cellular communication network service at block 310. The first UE 106 may receive a confirmation of receipt 136 of the SOS message 112 from the PSAP 128 via the cellular communication network service at block 312, and begin communicating with the PSAP 128 at block 314. Instead of determining whether the short-range wireless communication has been established with the second UE 114 at block 302, the first UE 106 may alternatively determine whether the confirmation of receipt 136 is received.

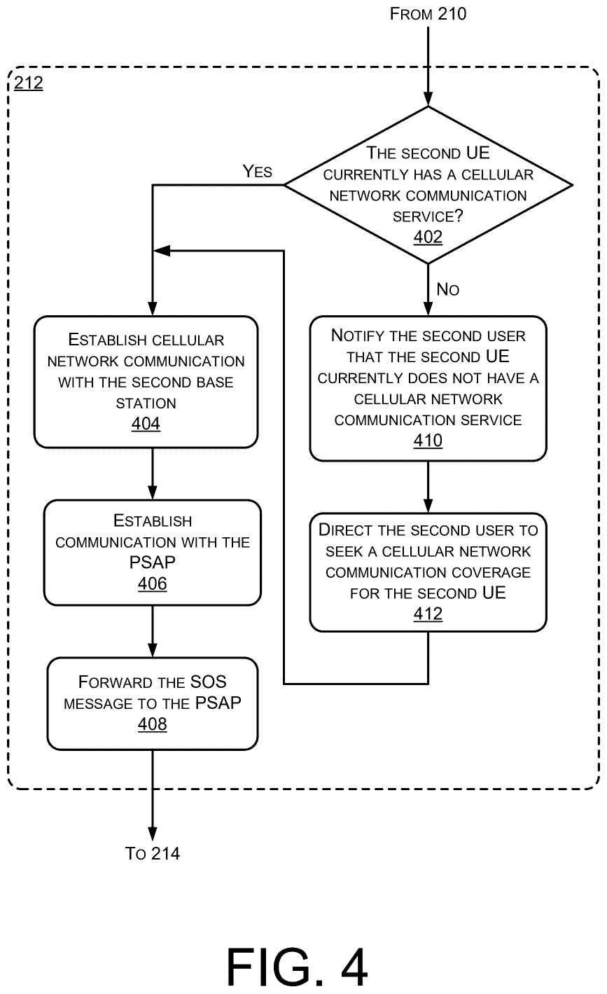

FIG. 4 illustrates an example detail process of block 212 of FIG. 2. While the first UE 106 may successfully establish communication with the second UE 114 using the short-range wireless communication 126 and transmit the SOS message 112 to the second UE 114, the second UE 114 does not necessarily have a cellular communication network service at the time of receiving the SOS message 112. At block 402, the second UE 114 may determine, or be caused to determine whether the second UE 114 currently has a cellular network communication service in response to receiving the SOS message 112. If the second UE 114 is determined to have a cellular network communication service (“YES” branch), then, at block 404, the second UE 114 may establish, or be caused to establish, communication with an available base station, such as the second cellular network communication 132 with the second base station 130. The second UE 114 may establish, or be caused to establish, communication with the PSAP 128 at block 406, and may forward, or be caused to forward the SOS message 112 to the PSAP 128 at block 408. The process then proceeds to block 214.

If the second UE 114 is determined not to have a cellular network communication service (“No” branch), the second UE 114 may generate, or be caused to generate, an alert notifying the second user 120 that the second UE 114 currently does not have a cellular network communication service at block 410. The alert may include one or more of audible, vibrational, and visual notifications, and may direct the second user 120 to seek a cellular network communication service for the second UE 114, for example, by moving to a different location, at block 412. The process may then proceed to block 404 where the second UE 114 may establish, or be caused to establish, the second cellular network communication 132 with the second base station 130, and the second UE 114 may notify, or be caused to notify, the second user 120 that the second cellular network communication 132 with the second base station 130 has been established. The second UE 114 may establish, or be caused to establish, communication with the PSAP 128 at block 406, and may forward, or be caused to forward the SOS message 112 to the PSAP 128 at block 408 as described above. The process may then proceed to block 214.

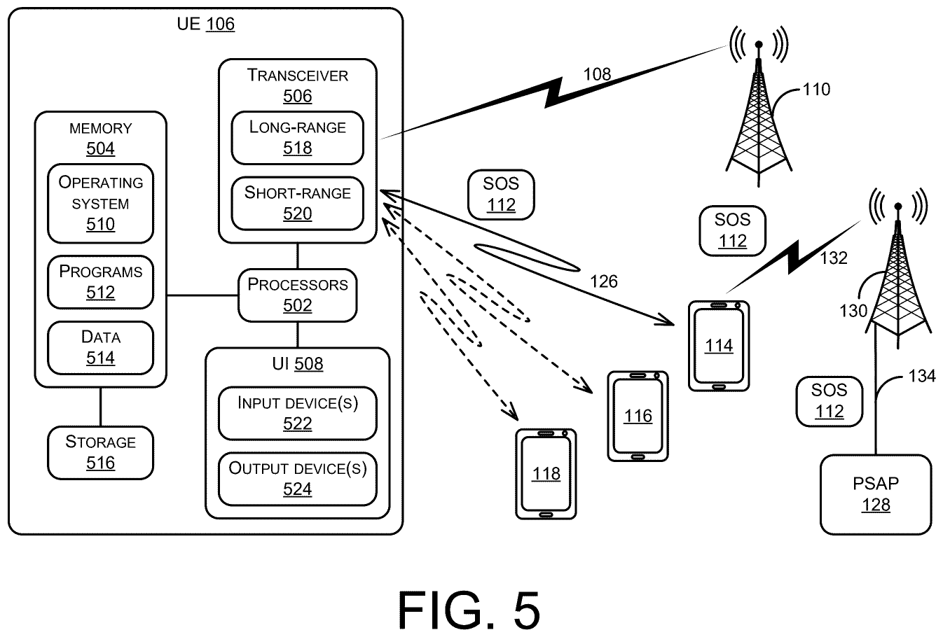

FIG. 5 is an example block diagram of a UE, such as the first UE 106, that may be used to implement various methods, components, modules, and/or functional elements of the short-range communication device emergency response system discussed above. In various embodiments, the first UE 106 may include at least one or more processors (processors) 502, memory 504 coupled to the processors 502, a transceiver 506 coupled to the processors 502, and a user interface (UI) 508 coupled to the processors 502.

The processors 502 can be a central processing unit (CPU), a graphics processing unit (GPU), or both CPU and GPU, or any other type of processing unit. Each of the one or more processors 502 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processors 502 may also be responsible for executing all computer applications stored in the memory 504.

Depending on the exact configuration and type of the first UE 106, the memory 504 may be volatile (such as RAM), non-volatile (such as ROM, flash memory, etc.) or some combination of both. The memory 504 may include, or store, an operating system 510, one or more program modules 512, and may include program data 514. The first UE 106 may also include additional data storage devices (removable and/or non-removable) such as, for example, a flash drive, an SD card, magnetic disks, optical disks, or tape. Such additional storage is illustrated in FIG. 4 by a storage 516.

Non-transitory computer-readable storage media of the first UE 106, such as the memory 504 and the storage 516, may include volatile and nonvolatile, removable and non-removable media implemented in any method or technology for storage of information, such as computer-readable instructions, data structures, program modules, or other data. The memory 504 and storage 516 are all examples of computer-readable storage media. Non-transitory computer-readable storage media includes, but is not limited to, phase change memory (PRAM), static random-access memory (SRAM), dynamic random-access memory (DRAM), RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store the desired information and which can be accessed by the processors 502 of the first UE 106. In contrast, communication media may embody computer-readable instructions, data structures, program modules, or other data in a modulated data signal, such as a carrier wave, or other transmission mechanism. As defined herein, non-transitory computer-readable storage media do not include communication media.

The computer-readable instructions stored on one or more non-transitory computer-readable storage media, such as the memory 504 and the storage 516, when executed by one or more processors, such as the processors 502 may perform operations described above with reference to FIGS. 1-4. For example, the programs 512 may include the emergency communication application. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

The transceiver 506 may include a long-range transceiver 518 and a short-range transceiver 520. The long-range transceiver 518 may include one or more transceivers for communicating over cellular networks, such as 2G, 3G, 4G, 5G, and/or other cellular-wireless access technologies, which may be used to access, or attempt to access, the first base station 110 to reach the PSAP 128 as discussed above with reference to FIGS. 1-4. The short-range transceiver 520 may include one or more transceivers for communicating using short-range wireless communication schemes, such as Bluetooth, WiFi, ZigBee, NFC, and other communication methods, which may be used to broadcast the SOS message 112 and establish communication with the second UE to reach the PSAP 128 as discussed above with reference to FIGS. 1-4.

The UI 508 may include input device(s) 522 such as a keyboard, a mouse, a touch-sensitive display, voice input device, etc. Output device(s) 524 such as a display, speakers, a printer, etc. may also be included. For example, upon the activation of the emergency communication application, the first UE 106 may display on the touchscreen display as the output device 524, or audibly reproduce on the speaker as the output device 524, the inquiries to the first user 102 for preparing the SOS message 112 to be sent to the PSAP 128 as described above with reference to FIG. 2. The first user 102 may then enter the response to the inquiries using the touchscreen display as the input device 522, or speak the response into the microphone as the input device 522, as described above with reference to FIG. 1.

Although features and/or methodological acts are described above, it is to be understood that the appended claims are not necessarily limited to those features or acts. Rather, the features and acts described above are disclosed as example forms of implementing the claims.

What is claimed is:

1. A method performed by a processor of a first user equipment (UE) comprising:
activating an emergency communication application;
in response to activating the emergency communication application, searching for a cellular communication network service for the first UE;
in response to failing to obtain the cellular communication network service, broadcasting an SOS message using a short-range wireless communication scheme;
establishing communication with a second UE using the short-range wireless communication scheme; and
causing the second UE to:
establish communication with a public-safety answering point (PSAP) using an available cellular communication network service for the second UE, and
forward the SOS message to the PSAP.

2. The method of claim 1, wherein broadcasting the SOS message using the short-range wireless communication scheme includes periodically broadcasting the SOS message.

3. The method of claim 1, wherein the SOS message comprises preselected information.

4. The method of claim 3, wherein the preselected information includes a time stamp corresponding to a time of the activation of the emergency communication application, a location of the first UE at the time of the activation, an identity of the first UE, and personal information of a user of the first UE.

5. The method of claim 1, wherein the SOS message comprises a preselected information and is supplemented with information entered after the activation of the emergency communication application.

6. The method of claim 1, further comprising:
receiving a confirmation of receipt of the SOS message from the PSAP via the second UE; and
ending broadcasting the SOS message.

7. The method of claim 6, further comprising, prior to receiving the confirmation:
establishing communication with one or more UEs of a plurality of UEs using the short-range wireless communication scheme, the second UE being one of the one or more UEs; and
causing the one or more UEs to attempt establishing communication with the PSAP using respective available cellular communication network services for the one or more UEs.

8. The method of claim 7, wherein receiving the confirmation includes:
causing the PSAP to send the confirmation to the first UE in response to the PSAP receiving the SOS message; and
causing the PSAP to send a neutralizing message to the one or more UEs to stop attempting to establish communication with the PSAP.

9. The method of claim 8, wherein the neutralizing message includes a unique identifier identifying the SOS message.

10. The method of claim 1, further comprising:
in response to failing to obtain the cellular communication network service, periodically re-searching for the cellular communication network service; and
in response to obtaining the cellular communication network service before establishing communication with the second UE:
establishing communication with the PSAP using the cellular communication network service, and
forwarding the SOS message to the PSAP.

11. A user equipment (UE) comprising:
one or more processors;
a transceiver coupled to the one or more processors; and
one or more non-transitory computer-readable media coupled to the one or more processors, the one or more non-transitory computer-readable media storing computer-executable instructions that, when executed by the one or more processors, cause the one or more processors to perform operations, the operations comprising:
activating an emergency communication application;
in response to activating the emergency communication application, searching for a cellular communication network service for the UE using the transceiver;
in response to failing to obtain the cellular communication network service, broadcasting an SOS message using a short-range wireless communication scheme using the transceiver;
establishing communication with another UE using the short-range wireless communication scheme; and
causing the another UE to:
establish communication with a public-safety answering point (PSAP) using an available cellular communication network service for the another UE, and
forward the SOS message to the PSAP.

12. The UE of claim 11, wherein the SOS message comprises preselected information, the preselected information including a time stamp corresponding to a time of the activation of the emergency communication application, a location of the UE at the time of the activation, an identity of the UE, and personal information of a user of the UE.

13. The UE of claim 11, wherein the operations further comprise:
receiving a confirmation of receipt of the SOS message from the PSAP via the another UE; and
ending broadcasting the SOS message.

14. The UE of claim 13, wherein the operations further comprise, prior to receiving the confirmation:
establishing communication with one or more UEs of a plurality of UEs using the short-range wireless communication scheme, the another UE being one of the one or more UEs; and
causing the one or more UEs to attempt establishing communication with the PSAP using respective available cellular communication network services for the one or more UEs.

15. The UE of claim 14, wherein receiving the confirmation includes:
causing the PSAP to send the confirmation to the UE in response to the PSAP receiving the SOS message; and
causing the PSAP to send a neutralizing message to the one or more UEs to stop attempting to establish communication with the PSAP, the neutralizing message including a unique identifier identifying the SOS message.

16. The UE of claim 11, wherein the operations further comprise:
in response to failing to obtain the cellular communication network service, periodically re-searching for the cellular communication network service; and
in response to obtaining the cellular communication network service before establishing communication with the another UE:
establishing communication with the PSAP using the cellular communication network service, and
forwarding the SOS message to the PSAP.

17. One or more non-transitory computer-readable media storing computer-executable instructions that, when executed by one or more processors of a first UE, cause the one or more processors to perform operations, the operations comprising:
activating an emergency communication application;
in response to activating the emergency communication application, searching for a cellular communication network service for the first UE;
in response to failing to obtain the cellular communication network service, broadcasting an SOS message using a short-range wireless communication scheme;
establishing communication with a second UE using the short-range wireless communication scheme;
causing the second UE to:
establish communication with a public-safety answering point (PSAP) using an available cellular communication network service for the second UE, and
forward the SOS message to the PSAP,
receiving a confirmation of receipt of the SOS message from the PSAP via the second UE; and
ending broadcasting the SOS message.

18. The one or more non-transitory computer-readable media of claim 17, wherein the operations further comprise, prior to receiving the confirmation:
establishing communication with one or more UEs of a plurality of UEs using the short-range wireless communication scheme, the second UE being one of the one or more UEs; and
causing the one or more UEs to attempt establishing communication with the PSAP using respective available cellular communication network services for the one or more UEs.

19. The one or more non-transitory computer-readable media of claim 18, wherein receiving the confirmation includes:
causing the PSAP to send the confirmation to the first UE in response to the PSAP receiving the SOS message; and
causing the PSAP to send a neutralizing message to the one or more UEs to stop attempting to establish communication with the PSAP.

20. The one or more non-transitory computer-readable media of claim 17, wherein the operations further comprise:
in response to failing to obtain the cellular communication network service, periodically re-searching for the cellular communication network service; and
in response to obtaining the cellular communication network service before establishing communication with the second UE:
establishing communication with the PSAP using the cellular communication network service, and
forwarding the SOS message to the PSAP.
